(19) United States
(12) Patent Application Publication
(10) Pub. No.: US 2012/0215520 A1
(43) Pub. Date: Aug. 23, 2012

(54) Translation System

(76) Inventor: Janel R. Davis, Milwaukee, WI (US)

(21) Appl. No.: 13/033,087

(22) Filed: Feb. 23, 2011

(51) Int. Cl. G06F 17/28

(52) U.S. Cl. 704/3

(57) ABSTRACT

A translation system that accepts verbal and typed words and ultimately serves to recognize the specific language of these words. An electronic apparatus collects spoken and typed words such that the words are stored within the system. A multiple-language database operates in communication with a translation mechanism to identify which language is being contained within the electronic apparatus. The words are then translated and presented to a user via audio and visual means. A virtual character also can be created such that verbal or typed words are translated into sign language and presented in sequence via a display screen.

### FIELD OF THE INVENTION

The present invention relates to a translation system for both verbal, typed and sign speech that recognizes words in terms of specific language and translation, and then provides a user the ability to initiate a translation mechanism contained within the electronic apparatus so that the spoken or typed words are played back to the user in a translated format in conjunction with a preprogrammed multiple-language database.

### BACKGROUND OF THE INVENTION

There are about 6,900 different languages spoken in the world, according to most general accountings. Of this number, the book “Ethnologue: Languages of the World” claims that about 60 percent of the Earth's global population in fact is fluent in at least one of 30 languages. This means that 40 percent of the world speaks what some may refer to as more obscure languages, while the slight majority of the population is still fragmented into multiple forms of communication. This means that ranging from the ancient story of the Tower of Babel to our current global economy, the time-tested issue of language barriers and communication remains as relevant as ever.

Today, more than a billion people speak Mandarin Chinese. This accounts for the largest amount of native-language speakers in the world. Other top languages include Hindi, English, Spanish, Russian, and Arabic, just to name a few. Furthermore, languages are not limited to just words, but also dialects. For example, speakers from Yemen speak a different version of Arabic from those in Iraq. The result is an even more fractious and confusing world. Therefore, a problem exists as to bridging these gaps in a user-friendly, practical manner for people encountering others and needing or wanting to communicate on the fly.

Communication lies at the heart of business. It also is an important factor relating to recreational travel. But even beyond these common scenarios, the need for quick and practical communication on the fly delves into other more compelling items. For example, foreign aid workers, international investigators, and military personnel often find themselves in ethnically/culturally diverse corners of the world. This means that interpreters may not be readily available to handle the varying forms of communication that are being flung upon them, often under trying conditions. At the same time, other intangibles such as taking notes and documentation become literally lost in translation as the various sets of native speakers attempt to communicate. As such, a significant problem exists in not only providing a more independent means of mutual communication, but also note taking and documentation.

The present invention solves this problem by incorporating a recording element, translation mechanism, and a multiple-language database into an electronic apparatus complete with display screen, keypad, and ability to create a virtual character. Through these elements, the present invention serves to recognize, identify and translate the languages and/or dialects of different speakers in both audio and visual formats. At the same time, these conversations are recorded and saved for future documentation. Recording and documentation are also important in other multi-language circumstances such as police investigations and social work calls.

The system of the present invention differs from typical translation devices that do not solve the problem of language recognition, whereas the present invention does recognize each language spoken during the translation process. For example, imagine a scientific conference with scientists from all over the world. Each scientist addresses the audience in her native tongue; one scientist speaks French, another Russian, another Rumanian, and so on. The present invention will record, store, recognize, then translate each of the languages spoken into a pre-designated default language, associating each language with each speaker's voice. Furthermore, upon playback the present invention incorporates the virtual character aspect that further assists in conveying the translation into the pre-designated default language.

The above-stated problems are solved by the novel aspects of the present invention. But the present invention also assists in the creative context. For example, there is an industry that caters to fictional and “made-up” languages. This includes such cult-followings as the Klingon language of the science fiction Star Trek universe or the magical spells of the Harry Potter book and movie series. Entire books are sold to consumers looking to learn these “languages.” The present invention can be customized to translate to and from such fictional languages via programming within its multiple-language database and translation mechanism. This will assist such users in indulging their creative inclinations as well as spurring additional creativity and even unique codes or words among select groups of people.

It also should be noted that another related issue pertaining to communication involves people who are hearing impaired. Sign language is often a vital means of communication when it comes to the deaf or hearing impaired. According to the National Institute on Deafness and Other Communication Disorders (NIDCD), the American Sign Language (ASL) is a complete, complex language that employs signs made with the hands and other movements, including facial expressions and postures of the body. NIDCD contends that ASL is the first language of many deaf North Americans, and one of several communication options available to deaf people. Moreover, ASL is said to be the fourth most commonly used language in the United States. As a result, the problem exists of having non-ASL speakers trying to communicate with the hearing impaired without the benefit of ASL training or background.

The present invention solves this problem. Just as described above, the present invention can pre-program sign language into its multiple-language database. In this manner, a user can speak within the vicinity of the electronic apparatus and then active the translation mechanism. The language of the user will be recognized as it is translated into signs. A virtual character on the display screen will then employ the signs so that the recipient of the sign language can watch. This aspect of employing the virtual character is novel and helpful. The reason is because hand signals are not the only element to most sign language. Facial expressions and body positioning also play an important role in properly conveying the intended communication. In addition, just as there are different dialects and languages in the world, there also are different forms of sign language. While ASL is an important and prominent “dialect,” there are other forms such as British Sign Language (BSL). As with the means described above, the present invention solves this problem by preprogramming varying forms of sign language.

U.S. Pub. No. 2002/0152077 filed by Patterson on Oct. 17, 2002, is a sign language translator. Patterson employs a glove and sensors in order to translate hand signals into sign language. In contrast, the present invention employs an electronic apparatus that recognizes both audio speech and typed speech, which is ultimately translated and displayed via a virtual character. This difference is profound because while Patterson seeks to translate the physical hand signals, the present invention takes it an important step further by conducting a more thorough translation through preset facial and bodily motions via the virtual character display.

U.S. Pub. No. 2004/0034522 filed by Liebermann on Feb. 19, 2004 is a method and apparatus for seamless translation of voice and/or text into sign language. Liebermann seeks to create a database of images to use in translating. In contrast, the present invention differs from Liebermann and others due to the present invention's incorporation of the electronic apparatus and its sign language emphasis and utility relating to the virtual character. The present invention also employs its functionality in a more instant manner as described in more detail below. The present invention also properly incorporates its usage into recordings or saved files within the electronic apparatus. Similar differences relate to other sign-language translation devices such as U.S. Pat. No. 5,473,705 issued to Abe et al. on Dec. 5, 1995; U.S. Pat. No. 5,953,693 issued to Sakiyama on Sep. 14, 1999; and U.S. Pat. No. 7,110,946 issued to Belenger et al. on Sep. 19, 2006.

U.S. Pat. No. 5,758,946 issued to Bordeaux on May 26, 1998 is a multi-language speech recognition system. Bordeaux maintains predetermined spoken languages and translates inputted speech. In contrast, the present invention integrates its translation elements via first saving and recording the typed or audio sounds that are inputted into the electronic apparatus. In addition, the present invention provides a sequence where the user can opt to use the electronic apparatus to replay the translation via audio, visual or both. Moreover, the user can create the virtual character which will replay the translation. Bordeaux also does not account for sign language and its various physical nuances. Similarly, the present invention contrasts with other translation devices and methods such as U.S. Pat. No. 5,963,892 issued to Tanaka et al. on Oct. 5, 1999; and U.S. Pat. No. 6,356,865 issued to Franz et al. on Mar. 12, 2002.

The present invention solves the need for a system for portable translation relating to multiple-language environments where recording and documentation are an additionally essential aspect. In addition, the present invention incorporates into its system the ability to more efficiently translate sign language in regard to physical aspects beyond merely hands. The present invention employs this system in a manner that is novel and beneficial.

### SUMMARY OF THE INVENTION

The present invention is a translation system. The system of the present invention relates to an electronic apparatus. The electronic apparatus is comprised of conventional components that facilitate the method of the system in terms of overall functionality. The translation elements in the preferred embodiment pertain to audible spoken words. In addition, sign language is conveyed via a display screen and keypad operating in communication with the electronic apparatus. Ultimately, the present invention serves to identify and translate the language being spoken near the electronic apparatus.

The electronic apparatus in the preferred embodiment includes a conventional recording component. The recording component is configured to receive sound emanating from a specific range, direction and distance. A multiple-language database is preprogrammed and contained within the electronic apparatus. When a user activates the recording component, the electronic apparatus via conventional means receives and records the targeted words being spoken within the specific range. The “stored words” are then translated into a pre-designated default language by the activated translation mechanism that operates in communication with the recording component and the multiple-language database. When the translation mechanism is activated, the spoken words that had been previously recorded via the recording component will be recognized by the multiple-language database. Recognition means assessing which language is being spoken. Once the specific language is recognized by the electronic apparatus of the present invention, the electronic apparatus will convey a translation to the user via either audio or visual means.

An additional function of the present invention relates to sign language. In this embodiment of the present invention, a user will speak within range of the electronic apparatus. In a similar manner as described above in terms of pure verbal speech, the present invention will recognize the spoken words and translate the words onto the display screen. In this manner, the display screen will initiate a sequence of signs that appear in an understandable manner to someone who understands sign language. An additional embodiment of the present invention permits a user to create a character to understand and convey the sign language via the display screen.

### BRIEF DESCRIPTION OF THE DRAWINGS

FIG. 1 is an embodiment of the electronic apparatus of the present invention.

FIG. 2 is a flow chart relating to the process of the present invention.

### DETAILED DESCRIPTION OF THE PREFERRED EMBODIMENT(S)

The present invention is a translation system that employs various conventional components contained within an electronic apparatus (10). The preferred embodiment of the electronic apparatus (10) is meant to fit in the hand of a user. The electronic apparatus (10) is configured to receive power via conventional batteries, USB or traditional wall and plug. In the preferred embodiment of the present invention, an on-button (20) can be initiated by a user. Once the on-button (20) is initiated, a conventional circuit between the power source and the electronic apparatus (10) will be closed such that the electronic apparatus (10) will receive power. An off-button (30), when initiated, serves to open the circuit and consequently cut off the power supply to the electronic apparatus (10).

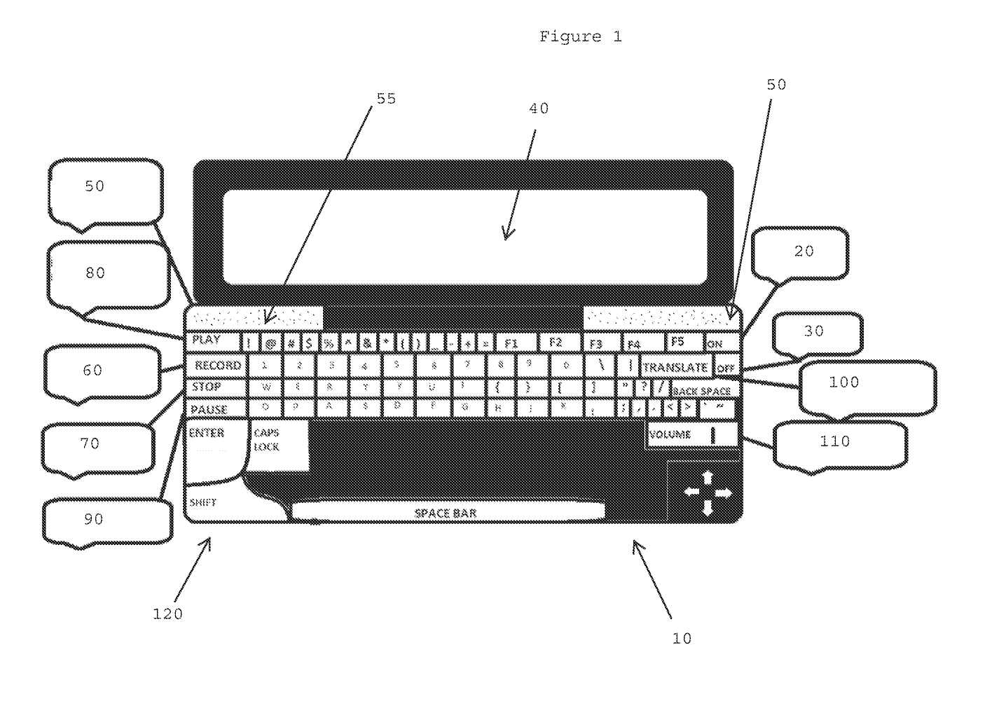

As we see in FIG. 1, a display screen (40) is connected to the electronic apparatus (10). The display screen (40) operates via conventional means and is configured to display images and words. Moreover, speakers (50) operate in communication with the system of the present invention such that sounds can be emitted. It also should be noted that the electronic apparatus (10) of the present invention is configured via conventional means to not only emit sounds, but also to receive sounds via conventional means. In the preferred embodiment of the present invention, the receiver (55) is located within the electronic apparatus (10) such that the receiver (55) is configured to collect words that are spoken within its vicinity. The ability to receive sounds is contingent upon the range of the receiver (55). The receiver (55) is configured to filter out ambient noise via conventional means such that spoken words are isolated and collected.

When words are being spoken within the vicinity of the receiver (55), a user may initiate the record button (60). The record button (60) is a conventional recording device that saves and collects the words that were being spoken during the duration of the record button (60) activation. A stop recording button (70) will cease the saving and collection process via conventional means. The record button (60) and stop recording button (70) operate in communication with a memory storage component contained within the electronic apparatus (10). The memory storage component is conventional and, in the preferred embodiment of the present invention, is configured to save and collect the recorded words via digital means. A playback button (80) can be initiated by the user to retrieve the recorded words from the memory storage component such that the recorded words are played back. A pause recording button (90) and a delete recording aspect also are envisioned for increased functionality during the recording process.

A translate button (100) allows the user to initiate the translating process of the present invention. The translate button (100) is in communication with the memory storage component and an internal translation mechanism. The translation mechanism operates via conventional means. Once initiated via the translation button (100), the translation mechanism is configured to intake the recorded or typed words. These words become stored within the present invention. From there, the translation mechanism passes the recorded, or stored, words through a multiple-language database. The multiple-language database is contained within the electronic apparatus (10) in the preferred embodiment, although an additional embodiment envisions conventional wireless communication between the electronic apparatus (10) and a remote server. In the wireless version, the multiple-language database is located within a remote server where the pertinent data is stored. Regardless of the location of the multiple-language database, the data contained within the multiple-language database relates to various languages. The languages are conventionally pre-programmed into the multiple-language database such that all facets of the unique linguistics of each separate language are available. This includes items such as conjugation, sentence structure and slang. A separate setting within the electronic apparatus (10) initiated by the user will dictate the designated language that the recorded words are to be translated into.

Once the translation button (100) is initiated, the recorded or stored words will run through the process as described above. The translation mechanism, via the multiple-language database, will recognize the language recorded and contained within the memory storage component. However, the present invention will only recognize the language if the specific language being recorded and saved is pre-programmed within the multiple-language database. After the translation button (100) is initiated, the user can employ the playback button (80) or other comparable means to emit the translation. For example, if the present invention recorded and saved French and the desired language setting on the electronic apparatus (10) was English, then the replayed translation will be in English. The replayed translation in the preferred embodiment will be either audio via the speakers (50), visual via the display screen (40), or both. The manifestation of the translation in the preferred embodiment can be established by the user. It also is envisioned that the electronic apparatus (10) will be configured to have a volume control button (110). Moreover, the preferred embodiment of the present invention allows for the display screen (40) to identify the original language gleaned from either the recorded or typed words. In this manner, a truly foreign language will be identified to the user.

The present invention also employs a keypad (120). The keypad (120) allows a person to type words into the electronic apparatus (10) such that the words are displayed on the display screen (40). The user may then initiate the translate button (100) whereby the translation process as described above will initiate vice the connection to the recording device. Moreover, the typed words can be translated such that an image on the display screen (40) will demonstrate the typed translation in sign language. The preferred programmed sign language is American Sign Language, although other versions or variations can be implemented into the multiple-language database.

An additional embodiment of the present invention relates to the translation of recorded words to sign language display via the display screen (40). In this embodiment, the present invention records and saves words in the same manner as described above. Once the translate button (100) is initiated, the user can set the electronic apparatus (10) to translate words into sign language. This means that the present invention will recognize whatever language is being spoken via the process described above, and this language will be translated into sign language. The sign language will then be conveyed via the display screen (40) such that the length of the recorded words will be conveyed in conversational format such as a typical audio playback. But instead of words being played back, the sequence of signs will be made.

In the preferred embodiment of the present invention, a user may use the electronic apparatus (10) to create a virtual character. The virtual character will ultimately be viewed on the display screen (40) and is meant to provide a personalized character to present the sign language and/or speak the translated language. The user will use the keypad (120) to control various menu options that can be called up on the display screen (40). In this manner, the user will be presented with choices pertaining to the virtual character display, such as gender, hair color, clothing, shoes, eyes, tone, hats, glasses and accessories. It is this same process in the preferred embodiment of using the keypad (120) and display screen (40) menu items to set the default language.

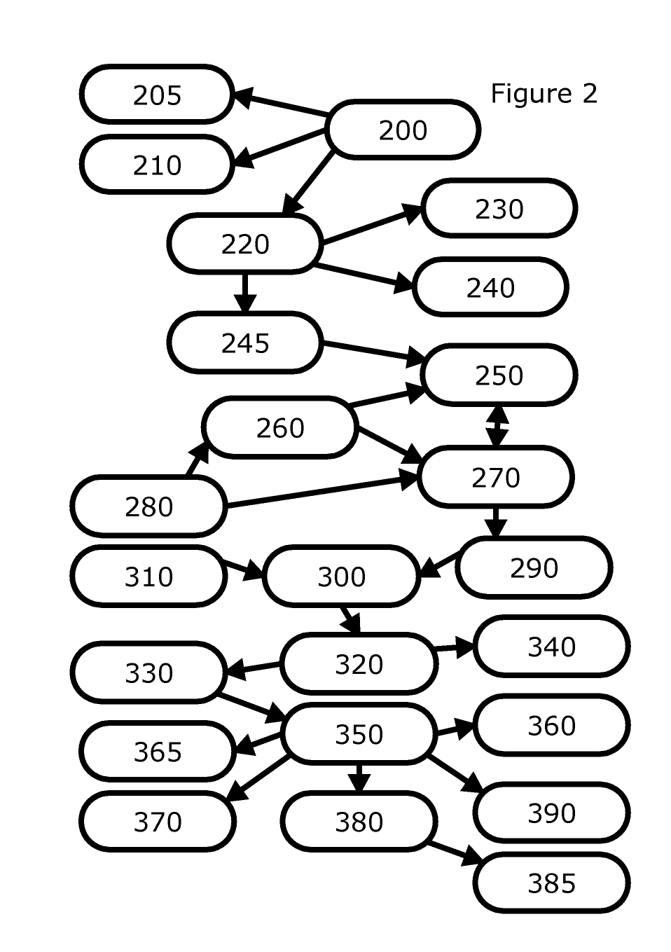

The above description, coupled with FIG. 1, details many of the physical elements of the present invention. FIG. 2 provides a flow chart relating to the process of the present invention. Many of the details and components relating to this process are described above. The first step of the present invention is for a user to activate the electronic apparatus (200). A default language setting may be selected (210) by the user so that all translations are conveyed in this specific language. The user also may create a virtual character (205) as described above. When the user encounters a person or voice that is speaking a different language, the user will initiate the record button (220). The user has the option of pausing the recording (230) or stopping the recording (240). While the user initiates the record button (220), the targeted words are received (245). These received words are saved and collected (250).

The user then initiates the translation button (260). Once this occurs, the internal translation mechanism is activated (270). However, a user also may bypass the recording aspect of the present invention and type words on the keypad (280). When the internal translation mechanism is activated (270), the translation mechanism intakes either the recorded or typed words (290). The either recorded or typed words are then passed through the multiple-language database (300). The multiple-language database will have already been preprogrammed with languages (310). Once either recorded or typed words are passed through the multiple-language database (300), the either recorded or typed words are determined to be recognizable (320). If the either recorded or typed words are not recognized by the multiple-language database (330), then there can be no translation because the recording may have not properly picked up the sound, or the multiple-language database was not preprogrammed for that particular language.

If the either recorded or typed words are recognized (330), then the user will be able to playback the translation (350). At this point, the user may adjust the volume control (360). In addition, a preferred embodiment of the present will use the display screen to indicate the original language gleaned from the either recorded or typed words (365). The user also will have the option of replaying the translation in either audio (370), visual (380) or both formats (390). If visual (380) is selected, the virtual character will appear on the display screen (385) if the virtual character was created earlier in the process. If the selected default language is sign language, then the only option for translation replay will be visual (380), where the virtual character will appear on the display screen (385) and convey the sign language.

1. A translation system, comprising:
configuring an electronic apparatus to receive audible words;
permitting a user to record the audible words;
storing the audible words within the electronic apparatus via a recording button and a memory storage component, the audible words becoming stored words;
recognizing a specific language of the stored words via a translation mechanism;
translating the stored words into a pre-designated default language via a multiple-language database, the stored words becoming translated words; and
presenting the translated words via audio and visual means.

2. The translation system of claim 1, further comprising connecting at least one speaker and a display screen to the electronic apparatus.

3. The translation system of claim 1, further comprising permitting a user to record the audible words via a receiver located within the electronic apparatus.

4. The translation system of claim 3, further comprising configuring the receiver to filter out ambient noise.

5. The translation system of claim 3, further comprising limiting the range of the receiver to words spoken in the vicinity of the electronic apparatus.

6. The translation system of claim 1, further comprising placing a translate button in communication with the memory storage component and the translation mechanism.

7. The translation system of claim 6, further comprising configuring the translation mechanism to intake the spoken words that are recorded such that the spoken words become the stored words.

8. The translation system of claim 6, further comprising configuring the translation mechanism to intake words that are typed into the electronic apparatus via a keypad such that the typed words become the stored words.

9. The translation system of claim 1, further comprising passing the stored words through the multiple-language database.

10. The translation system of claim 1, further comprising populating the multiple-language database with preset language information.

11. The translation system of claim 10, further comprising limiting translation ability to specific languages that are preset within the multiple-language database.

12. The translation system of claim 1, further comprising allowing the user to playback the translated words via a playback button.

13. The translation system of claim 1, further comprising identifying an original language of the audible words upon initiation of playback of the translated words.

14. The translation system of claim 1, further comprising allowing the user to create a virtual character via the keypad and menu options on the display screen.

15. The translation system of claim 14, further comprising configuring the virtual character to manifest on the display screen such that the virtual character appears to speak the translated words and also performs sign language when the sign language is selected by the user as the pre-designated default language.

16. The translation system of claim 1, further comprising permitting the stored words to be translated into sign language, a sign language sequence being conveyed via the display screen when the translation mechanism is activated.

17. A translation system, comprising:
configuring an electronic apparatus to receive audible words;
permitting a user to record the audible words;
storing the audible words within the electronic apparatus via a recording button and a memory storage component, the audible words becoming stored words;
recognizing a specific language of the stored words via a translation mechanism;
translating the stored words into a pre-designated default language via a multiple-language database, the stored words becoming translated words;
presenting the translated words via audio and visual means;
connecting at least one speaker and a display screen to the electronic apparatus;
permitting a user to record the audible words via a receiver located within the electronic apparatus;
configuring the receiver to filter out ambient noise;
limiting the range of the receiver to words spoken in the vicinity of the electronic apparatus;
placing a translate button in communication with the memory storage component and the translation mechanism;
configuring the translation mechanism to intake the spoken words that are recorded such that the spoken words become the stored words;
configuring the translation mechanism to intake words that are typed into the electronic apparatus via a keypad such that the typed words become the stored words;
passing the stored words through the multiple-language database;
populating the multiple-language database with preset language information;
limiting translation ability to specific languages that are preset within the multiple-language database;
allowing the user to playback the translated words via a playback button;
identifying an original language of the audible words upon initiation of playback of the translated words;
allowing the user to create a virtual character via the keypad and menu options on the display screen;
configuring the virtual character to manifest on the display screen such that the virtual character appears to speak the translated words and also performs sign language when the sign language is selected by the user as the pre-designated default language; and
permitting the stored words to be translated into sign language, a sign language sequence being conveyed via the display screen when the translation mechanism is activated.
